(19) United States
(12) Patent Application Publication
(10) Pub. No.: US 2009/0155537 A1
(43) Pub. Date: Jun. 18, 2009

(54) PROCESS FOR PRODUCING THERMOPLASTIC ELASTOMER COMPOSITION FOAM BODY, AND THERMOPLASTIC ELASTOMER COMPOSITION FOR FOAM INJECTION MOLDING

(75) Inventors: Kazuyoshi Fuse, Chiba (JP); Yuya Yamamoto, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/331,526

(22) Filed: Dec. 10, 2008

(30) Foreign Application Priority Data
Dec. 12, 2007 (JP) 2007-320559
Dec. 12, 2007 (JP) 2007-320560

(51) Int. Cl. B32B 3/26; B29C 44/08; C08L 53/02

(52) U.S. Cl. 428/159; 264/55; 524/505

(57) ABSTRACT

A process for producing a thermoplastic elastomer composition foam body is provided that includes, in sequence, a step of injecting by an injection molding machine into a cavity of a mold for injection molding a foaming agent and a thermoplastic elastomer composition comprising component (A), component (B), and component (C) below, component (B) having a content of 5 to 150 parts by weight relative to 100 parts by weight of component (A) and component (C) having a content of 5 to 300 parts by weight relative to 100 parts by weight of component (A), a step of holding for not less than 4 seconds after completion of the injection, and a step of enlarging the volume of the cavity by moving a wall face of the cavity to a predetermined position. (A): A hydrogenated product of a block copolymer comprising a block composed of an aromatic vinyl compound-based monomer unit and a block composed of a conjugated diene compound-based monomer unit, (B): a propylene resin, and (C): a mineral oil. There are also provided a thermoplastic elastomer composition for foam injection molding, a foam body formed by foam injection molding of the thermoplastic elastomer composition, a process for producing a foam body employing the thermoplastic elastomer composition, and use of the thermoplastic elastomer composition as a composition for foam injection molding.

### BACKGROUND OF THE INVENTION

1. Field of the Invention

The present invention relates to a process for producing a thermoplastic elastomer composition foam body, and a thermoplastic elastomer composition for foam injection molding.

2. Description of the Related Art

Foam bodies formed from a styrenic thermoplastic elastomer composition comprising a polypropylene resin and a hydrogenated product of a block copolymer comprising a block composed of an aromatic vinyl compound-based monomer unit and a block composed of a conjugated diene compound-based monomer unit are used as foam members that are required to have flexibility, heat resistance, etc., such as automobile interior materials and consumer electronic members.

As a process for producing such a foam body, from the viewpoint of enhancing productivity a foam injection molding method is employed; for example, JP-A-6-218741 (JP-A denotes a Japanese unexamined patent application publication) describes a process for producing a foam body in which molding is carried out by injecting into a mold cavity a foaming styrenic thermoplastic elastomer comprising (a) 100 parts by weight of a styrenic thermoplastic elastomer component having a JIS-A hardness in accordance with JIS-K6301 of 40 to 95 and having a hydrogenated product of a styrene-conjugated diene block copolymer having an average molecular weight of not more than 150,000 as a base, and (b) 0.01 to 10 parts by weight of a foaming agent component, and then foaming by enlarging the cavity volume. Furthermore, JP-A-2006-175825 describes a composite molding formed by integrally molding a polyolefin-based composite resin layer disposed or injection-molded in a mold with a foamed layer by foam injection molding a foam layer composition, the foam layer composition comprising (a) a hydrogenated product of a block copolymer comprising an aromatic vinyl compound block and a conjugated diene compound block and having a weight-average molecular weight of not more than 200,000, (b) a propylene polymer, (c) a softening material for rubber, (d) a propylene polymer mixture comprising 30 to 70% by weight of a crystalline propylene polymer and, as the remainder, an amorphous copolymer comprising propylene and ethylene, the foam layer composition and the foamed layer having the properties that (A) the foam layer composition has a type A hardness in accordance with JIS-K6253 of not more than 80 and the foamed layer has an ASKER C surface hardness of not more than 75, (B) the foamed layer has a foam expansion ratio of not less than 1.2 times, (C) the foam layer composition has a melt spreadability of not less than 80 m/min at 170° C. to 190° C., and (D) with regard to a TMA measurement value of the foam layer composition in accordance with JIS-K7196, the temperature at 0.1 mm deformation is not less than 100° C. and the temperature at 0.5 mm deformation is not less than 120° C.

### BRIEF SUMMARY OF THE INVENTION

However, in the foam body formed by the conventional foam injection molding method from an aromatic vinyl compound-based thermoplastic elastomer composition, in particular a styrenic thermoplastic elastomer composition, due to the foamed cells being large or due to the size and shape of the foamed cells being nonuniform, the feel of softness might deteriorate, and the fineness of foamed cells and the uniformity of foamed cells are not fully satisfactory.

Under such circumstances, it is an object of the present invention to provide a process for producing by foam injection molding an aromatic vinyl compound-based thermoplastic elastomer composition foam body having foamed cells with excellent fineness and excellent uniformity.

Furthermore, it is another object of the present invention to provide an aromatic vinyl compound-based thermoplastic elastomer composition for foam injection molding that gives a foam body having foamed cells with excellent fineness and excellent uniformity by foam injection molding, a foam body formed by foam injection molding of the thermoplastic elastomer composition, and a process for producing a foam body by foam injection molding the thermoplastic elastomer composition.

The present invention provides [1] to [12] as follows:

[1] A process for producing a thermoplastic elastomer composition foam body comprising the steps of (i), (ii) and (iii), in this order,
(i) injecting by an injection molding machine into a cavity of a mold for injection molding a foaming agent and a thermoplastic elastomer composition comprising

100 parts by weight of component (A),

5 to 150 parts by weight of component (B), and

5 to 300 parts by weight of component (C),

(ii) holding for not less than 4 seconds after completion of the injection, and
(iii) enlarging the volume of the cavity by moving a wall face of the cavity to a predetermined position, wherein

component (A) is a hydrogenated product of a block copolymer comprising a block composed of an aromatic vinyl compound-based monomer unit and a block composed of a conjugated diene compound-based monomer unit,

component (B) is a propylene resin, and

component (C) is a mineral oil,

[2] the process according to [1], wherein in the step (iii) a rate of enlargement of cavity volume is not less than 700%/sec,
[3] the process according to [1] or [2] wherein, component (A) has a content of the block composed of the aromatic vinyl compound-based monomer unit of not less than 5% by weight but not more than 50% by weight, relative to 100% by weight of the total content of the block composed of the aromatic vinyl compound-based monomer unit and the block composed of the conjugated diene compound-based monomer unit,
[4] the process according to any one of [1] to [3], wherein component (A) has a degree of hydrogenation of not less than 50%,
[5] the process according to any one of [1] to [4], wherein component (A) has a weight-average molecular weight of not less than 50,000 but not more than 500,000,
[6] the process according to any one of [1] to [5], wherein component (B) has a melt flow rate under a load of 21.18 N at temperature 230° C. of not less than 0.1 g/10 minutes but not more than 300 g/10 minutes,
[7] the process according to any one of [1] to [6], wherein component (C) has an average molecular weight of not less than 300 but not more than 1,500 and a pour point of not more than 0° C.,
[8] a thermoplastic elastomer composition for foam injection molding, comprising

100 parts by weight of component (A′),

5 to 150 parts by weight of component (B′), and

5 to 300 parts by weight of component (C), wherein

component (A′) is a hydrogenated product of a block copolymer comprising a block composed of an aromatic vinyl compound-based monomer unit and a block composed of a conjugated diene compound-based monomer unit, the hydrogenated product having a weight-average molecular weight of not less than 200,000,

component (B′) is a propylene resin having a melt flow rate of 2 to 300 g/10 minutes and a melt tension of not less than 3 cN, and

component (C) is a mineral oil,

[9] the thermoplastic elastomer composition according to [8], further comprising component (B″), wherein the total content of component (B′) and component (B″) is 5 to 150 parts by weight relative to 100 parts by weight of component (A′), and component (B″) is a propylene resin having a melt flow rate of less than 2 g/10 minutes or a melt tension of less than 3 cN,
[10] a foam body formed by foam injection molding of the thermoplastic elastomer composition according to either [8] or [9],
[11] a process for producing a foam body, comprising the steps of

preparing the thermoplastic elastomer composition according to either [8] or [9], and

foam injection molding the thermoplastic elastomer composition, and

[12] use of the thermoplastic elastomer composition according to either [8] or [9] as a composition for foam injection molding.

### DETAILED DESCRIPTION OF THE INVENTION

The thermoplastic elastomer composition used in the present invention is a composition comprising 100 parts by weight of component (A), 5 to 150 parts by weight of component (B), 5 to 300 parts by weight of component (C).

The component (A) used in the present invention is a compound formed by hydrogenating a block copolymer comprising a block composed of an aromatic vinyl compound-based monomer unit (aromatic vinyl compound block) and a block composed of a conjugated diene compound-based monomer unit (conjugated diene compound block). Examples of the aromatic vinyl compound include styrene, α-methylstyrene, o-methylstyrene, m-methylstyrene, p-methylstyrene, 1,3-dimethylstyrene, vinyinaphthalene, and vinylanthracene, and styrene is preferable. With regard to these aromatic vinyl compounds, two or more types thereof may be used. Furthermore, examples of the conjugated diene compound include butadiene, isoprene, 1,3-pentadiene, and 2,3-dimethyl-1,3-butadiene, and butadiene and isoprene are preferable. With regard to these conjugated diene compounds, two or more types thereof may be used.

With regard to the content of the aromatic vinyl compound block and the conjugated diene compound block, from the viewpoint of enhancing the mechanical strength and the heat resistance of a foam body it is preferable for the content of the aromatic vinyl compound block to be not less than 5% by weight and for the content of the conjugated diene compound block to be not more than 95% by weight, and it is more preferable for the content of the aromatic vinyl compound block to be not less than 10% by weight and for the content of the conjugated diene compound block to be not more than 90% by weight. Furthermore, from the viewpoint of enhancing the flexibility of a foam body, it is preferable for the content of the aromatic vinyl compound block to be not more than 50% by weight and for the content of the conjugated diene compound block to be not less than 50% by weight, and it is more preferable for the content of the aromatic vinyl compound block to be not more than 40% by weight and for the content of the conjugated diene compound block to be not less than 60% by weight. Here, the total content of aromatic vinyl compound block and conjugated diene compound block is defined as 100% by weight. In addition, the content of the aromatic vinyl compound block means the total mount of aromatic vinyl compound blocks; for example, when the block copolymer is an aromatic vinyl compound block-conjugated diene compound block-aromatic vinyl compound block triblock copolymer, the total content of aromatic vinyl compound blocks is preferably the above content.

The content of each block is the content after hydrogenation.

The block copolymer may be a diblock copolymer having an aromatic vinyl compound block-conjugated diene compound block structure, or may be a triblock copolymer having an aromatic vinyl compound block-conjugated diene compound block-aromatic vinyl compound block structure.

The hydrogenated product of the block copolymer is one formed by partially or completely hydrogenating the double bonds of a conjugated diene compound-based monomer unit forming the conjugated diene compound block. From the viewpoint of enhancing the weatherability and the heat resistance of a foam body, the degree of hydrogenation, that is, with the amount of double bonds of the conjugated diene compound-based monomer unit of the block copolymer prior to hydrogenation as 100%, among the double bonds the amount of double bonds that are hydrogenated by hydrogenation of the block copolymer, is preferably not less than 50% but not more than 100%, and more preferably not less than 80% but not more than 100%.

From the viewpoint of enhancing the fineness of foamed cells, the uniformity of foamed cells and the mechanical strength of the foam body, the weight-average molecular weight of the hydrogenated product is preferably not less than 50,000, more preferably not less than 100,000. From the viewpoint of enhancing the oil resistance in addition to the fineness, the uniformity and the mechanical strength, the weight-average molecular weight of the hydrogenated product is yet more preferably not less than 200,000, particularly preferably not less than 250,000. Further, form the viewpoint of enhancing the formability, it is preferably not more than 500,000, more preferably not more than 400,000. The weight-average molecular weight is a weight-average molecular weight on a polystyrene basis, and is measured by a gel permeation chromatographic (GPC) method.

As an example of a process for producing the hydrogenated product, a block copolymer is produced by a method described in, for example, JP-B40-23798 (JP-B denotes a Japanese examined patent application publication), and the block copolymer is then hydrogenated by a method described in, for example, JP-B-42-8704, JP-B-43-6636, JP-A-59-133203, or JP-A-60-79005.

A commercial product may be used as the hydrogenated product. Examples thereof include ‘KRATON-G’ (trade name) manufactured by Kraton Polymers LLC, ‘SEPTON’ (trade name) manufactured by Kuraray Co., Ltd., and ‘Tuftec’ (trade name) manufactured by Asahi Kasei Corporation.

The component (B) used is a propylene resin, and examples thereof include a propylene homopolymer, and a copolymer of propylene and at least one type of comonomer selected from the comonomer group consisting of ethylene and an α-olefin having 4 to 10 carbons. The copolymer may be a random copolymer or a block copolymer. Specific examples of the copolymer include a propylene-ethylene copolymer, a propylene-1-butene copolymer, a propylene-1-hexene copolymer, a propylene-1-octene copolymer, a propylene-ethylene-1-butene copolymer, and a propylene-ethylene-1-hexene copolymer. Preferred propylene resins are a propylene homopolymer, a propylene-ethylene copolymer, and a propylene-1-butene copolymer. They may be used on their own or in a combination of two or more types.

The content of the propylene-based monomer unit (propylene unit) of a polymer used in the propylene resin is preferably greater than 50% by weight but not more than 100% by weight, more preferably greater than 60% by weight but not more than 100% by weight, and yet more preferably not less than 80% by weight but not more than 100% by weight. Here, the polymer is defined as 100% by weight.

The melt flow rate of the propylene resin is preferably 0.1 to 300 g/10 minutes, more preferably 0.5 to 200 g/10 minutes, and yet more preferably 1 to 150 g/10 minutes. The melt flow rate is measured in accordance with JIS K7210 with a load of 21.18 N at a temperature of 230° C.

The propylene resin may be produced by a known polymerization method using as a polymerization catalyst a Ziegler-Natta catalyst, a metallocene catalyst, etc. Examples of the polymerization method include a solution polymerization method, a bulk polymerization method, a slurry polymerization method, and a gas-phase polymerization method, and they may be employed in a combination of two or more types.

The component (C) used in the present invention is a mineral oil and functions as a softening agent; examples thereof include an aromatic-based mineral oil (aromatic mineral oil), a naphthene-based mineral oil (naphthenic mineral oil), and a paraffin-based mineral oil (paraffinic mineral oil), and it may comprise two or more types thereof. A paraffin-based mineral oil is preferable. Furthermore, the average molecular weight is preferably 300 to 1,500, and the pour point is preferably not more than 0° C.

In the present invention, it is also preferable to use as a thermoplastic elastomer composition a thermoplastic elastomer composition comprising component (A′), component (B′), and component (C) below.

(A′): A hydrogenated product of a block copolymer comprising a block composed of an aromatic vinyl compound-based monomer unit and a block composed of a conjugated diene compound-based monomer unit, the hydrogenated product having a weight-average molecular weight of not less than 200,000

(B′): A propylene resin having a melt flow rate of 2 to 300 g/10 minutes and a melt tension of not less than 3 cN

(C): A mineral oil

That is, a hydrogenated product (component (A′)) having a weight-average molecular weight of not less than 200,000 is used as component (A), and a propylene resin (component (B′)) having a melt flow rate of 2 to 300 g/10 minutes and a melt tension of not less than 3 cN is used as component (B).

It is also preferable, from the viewpoint of enhancing uniformity of foamed cells and the mechanical strength of a foam body, from among components (A) described above to use as component (A′) the hydrogenated product of a block copolymer having a weight-average molecular weight of not less than 200,000. In this case, it is more preferably not less than 220,000, and yet more preferably not less than 250,000. Furthermore, from the viewpoint of enhancing molding processability, the weight-average molecular weight is preferably not more than 500,000. The weight-average molecular weight is a weight-average molecular weight on a polystyrene basis, and is measured by a gel permeation chromatographic (GPC) method.

Furthermore, it is also preferable to use as component (B′) a propylene resin having a melt flow rate of 2 to 300 g/10 minutes and a melt tension of not less than 3 cN from among components (B) described above.

From the viewpoint of enhancing molding processability, the melt flow rate is preferably not less than 2 g/10 minutes, and more preferably not less than 3 g/10 minutes. Moreover, from the viewpoint of enhancing mechanical strength, it is not more than 300 g/10 minutes, and preferably not more than 200 g/10 minutes. The melt flow rate is measured in accordance with JIS K7210 with a load of 21.18 N at a temperature of 230° C.

From the viewpoint of enhancing the fineness of foamed cells and the uniformity of foamed cells, the melt tension is preferably not less than 3 cN, and more preferably not less than 4 cN. Furthermore, from the viewpoint of enhancing the molding processability, it is preferably not more than 500 cN, and more preferably not more than 300 cN. The melt tension is a tension measured when extruding a sample in a molten state, charged in a barrel having a barrel diameter of 9.55 mm, by a piston from an orifice having a length of 8 mm and a diameter of 2 mm provided at the tip of the barrel under conditions of a temperature of 190° C. and a piston descent speed of 5.7 mm/minute, and winding up the extruded molten sample at a rate of 15.7 m/minute.

As a process for producing a propylene resin for which the melt flow rate is 2 to 300 g/10 minutes and the melt tension is not less than 3 cN, there is, for example, a process for producing a crystalline propylene polymer component (component (b1)) having an intrinsic viscosity of 5 dL/g by polymerizing a monomer having propylene as a main component in a first stage, and then continuously producing a crystalline propylene polymer component (component (b2)) having an intrinsic viscosity of not more than 3 dL/g by polymerizing a monomer having propylene as a main component in a second stage and thereafter.

As component (b1) and component (b2), isotactic propylene polymers are preferable, and among them a propylene homopolymer, and a copolymer of propylene and at least one type of comonomer selected from the comonomer group consisting of ethylene and α-olefins having 4 to 10 carbon atoms are preferable. Examples of the α-olefin include 1-butene, 4-methylpentene-1,1-octene, and 1-hexene. When the comonomer is ethylene, the ethylene-based monomer unit content is preferably not more than 10% by weight, and when the comonomer is an α-olefin having 4 to 10 carbon atoms, the α-olefin-based monomer unit content is preferably not more than 30% by weight.

The intrinsic viscosity of component (b1) is preferably not less than 6 dL/g, and more preferably not less than 7 dL/g. Furthermore, the intrinsic viscosity of component (b1) is preferably not more than 100 dL/g, and more preferably not more than 50 dL/g.

The intrinsic viscosity of component (b2) is preferably not more than 2 dL/g. Furthermore, the intrinsic viscosity of component (b2) is not less than 0.1 dL/g, and preferably not less than 0.5 dL/g.

The intrinsic viscosity [η]_{b2} of component (b2) may be calculated from the equation below.

[η]_{b2}=([η]_{T}×100−[η]_{b1}×W_{b1})/W_{b2}

[η]_{T}: intrinsic viscosity of propylene resin (units: dL/g)

[η]_{b1}: intrinsic viscosity of component (b1) (units: dL/g)

W_{b1}: content of component (b1) (units: % by weight)

W_{b2}: content of component (b2) (units: % by weight)

(Total of W_{b1} and W_{b2} is 100% by weight.)

The polymerization ratio of component (b1) is preferably 0.05 to 25% by weight, and more preferably 0.3 to 20% by weight, relative to 100% by weight of the total content of component (b1) and component (b2).

As an olefin polymerization catalyst used in the production of component (b1) and component (b2), an olefin polymerization catalyst containing Ti, Mg, and a halogen as essential components can be cited; specifically, one described in JP-A-7-216017 can be used suitably.

As a process for producing component (b1) and component (b2) continuously, there can be cited a batchwise polymerization method in which after producing component (b1) component (b2) is subsequently produced in the same polymerization tank, a polymerization method in which at least two polymerization tanks are arranged in series, component (b1) is produced in a first stage polymerization tank, component (b1) is then transferred to a second stage polymerization tank, and component (b2) is produced in the second stage polymerization tank, etc.

As a process for producing component (b1) and component (b2), there can be cited a solvent polymerization method in which a hydrocarbon such as hexane, heptane, octane, decane, cyclohexane, methylcyclohexane, benzene, toluene, or xylene is used as a solvent; a bulk polymerization method in which a liquid monomer is used as a solvent; a gas-phase polymerization method in which polymerization is carried out in a gaseous monomer, etc. A bulk polymerization method and a gas-phase polymerization method are preferable.

In the production of component (b1) and component (b2), the polymerization temperature is preferably 20° C. to 150° C., and more preferably 35° C. to 95° C.

When a propylene resin (component (B′)) having a melt flow rate of 2 to 300 g/10 minutes and a melt tension of not less than 3 cN is used as propylene resin (B), a propylene resin (component (B″)) having a melt flow rate of less than 2 g/10 minutes and a melt tension of less than 3 cN may also be used in combination.

With regard to the propylene resin of component (B″) above, examples thereof include a propylene homopolymer, and a copolymer of propylene and at least one type of comonomer selected from the comonomer group consisting of ethylene and an α-olefin having 4 to 10 carbons. The copolymer may be a random copolymer or a block copolymer. Specific examples of the copolymer include a propylene-ethylene copolymer, a propylene-1-butene copolymer, a propylene-1-hexene copolymer, a propylene-1-octene copolymer, a propylene-ethylene-1-butene copolymer, and a propylene-ethylene-1-hexene copolymer. Preferred propylene resins (component (B″)) having a melt flow rate of less than 2 g/10 minutes or a melt tension of less than 3 cN are a propylene homopolymer, a propylene-ethylene copolymer, and a propylene-1-butene copolymer.

The content of the propylene-based monomer unit (propylene unit) of a polymer used in the propylene resin (component (B″)) having a melt flow rate of less than 2 g/10 minutes or a melt tension of less than 3 cN is preferably not less than 50% by weight, and more preferably not less than 80% by weight. Here, the polymer is defined as 100% by weight.

With regard to a propylene resin (component (B″)) having a melt flow rate of less than 2 g/10 minutes or a melt tension of less than 3 cN, the melt tension is preferably not more than 2 cN from the viewpoint of enhancing molding processability. Furthermore, from the viewpoint of enhancing the mechanical properties, it is preferably not less than 0.01 cN, and more preferably not less than 0.05 cN. The melt tension is a tension measured when extruding a sample in a molten state, charged in a barrel having a barrel diameter of 9.55 mm, by a piston from an orifice having a length of 8 mm and a diameter of 2 mm provided at the tip of the barrel under conditions of a temperature of 190° C. and a piston descent speed of 5.7 mm/minute, and winding up the extruded molten sample at a rate of 15.7 m/minute.

With regard to the propylene resin having a melt flow rate of less than 2 g/10 minutes or a melt tension of less than 3 cN, the melt flow rate thereof is preferably not less than 0.1 g/10 minutes, and more preferably not less than 0.3 g/10 minutes, from the viewpoint of enhancing molding processability. From the viewpoint of enhancing mechanical properties, it is preferably not more than 300 g/10 minutes, and more preferably not more than 200 g/10 minutes. The melt flow rate is measured in accordance with JIS K7210 with a load of 21.18 N at a temperature of 230° C.

The propylene resin having a melt flow rate of less than 2 g/10 minutes or a melt tension of less than 3 cN may be produced by a known polymerization method using as a polymerization catalyst a Ziegler-Natta catalyst, a metallocene catalyst, etc. Examples of the polymerization method include a solution polymerization method, a bulk polymerization method, a slurry polymerization method, and a gas-phase polymerization method, and they may be employed in a combination of two or more types.

In the present invention when, as propylene resin (B), a propylene resin (component (B′)) having a melt flow rate of 2 to 300 g/10 minutes and a melt tension of not less than 3 cN and a propylene resin (component (B″)) having a melt flow rate of less than 2 g/10 minutes or a melt tension of less than 3 cN are used in combination, the total amount of propylene resin is the component (B) content mentioned above.

The thermoplastic elastomer composition comprising component (A′), component (B′), and component (C) is suitable for use in foam injection molding, and is molded into a foam body. In this case, the injection molding method is not limited to an injection molding method described later, and is not particularly limited as long as a cavity of a mold of an injection molding machine is filled with a molten thermoplastic elastomer composition in which a foaming agent is dissolved, the molten thermoplastic elastomer composition is foamed within the mold, and the molten thermoplastic elastomer composition is subsequently cooled and solidified to thus give a foam molding.

As an injection method in foam injection molding, there can be cited as examples a single screw injection method, a multiple screw injection method, a high pressure injection method, a low pressure injection method, and an injection method using a plunger, etc. Furthermore, as an injection method, a method in which an inert gas, which is used as a physical foaming agent, is poured into a cylinder of an injection molding device in a supercritical state is preferable.

As a foaming method in foam injection molding, methods (1), (2), and (3) below can be cited as examples.

(1) A method in which an amount of foaming agent-containing molten thermoplastic elastomer composition that is smaller than the volume of a mold cavity is injected into the mold cavity, and the mold cavity is filled with the molten thermoplastic elastomer composition due to expansion of gas from the foaming agent, thus carrying out foaming.
(2) A method in which an amount of foaming agent-containing molten thermoplastic elastomer composition that fully fills the mold cavity with the foaming agent-containing molten thermoplastic elastomer composition is injected into the mold cavity, and expansion by a portion corresponding to the shrinkage volume of the thermoplastic elastomer composition accompanying cooling is carried out by means of gas from the foaming agent, thus carrying out foaming.
(3) A method in which an amount of foaming agent-containing molten thermoplastic elastomer composition that fully fills the mold cavity with the foaming agent-containing molten thermoplastic elastomer composition is injected into the mold cavity, and a cavity wall face of the mold is subsequently moved back to thus increase the cavity volume, thus making gas from the foaming agent expand and carrying out foaming.

As the foaming method in foam injection molding, a method in which an amount of foaming agent-containing molten thermoplastic elastomer composition that fully fills the mold cavity with the foaming agent-containing molten thermoplastic elastomer composition is injected into the mold cavity (fully-filled method) is preferable.

The thermoplastic elastomer composition used in the present invention may comprise various types of additives in a range that does not impair the object of the present invention. Specific examples of the additives include various types of antioxidants such as a phenol-based antioxidant, a phosphorus-based antioxidant, and a sulfur-based antioxidant; various types of thermal stabilizers such as a hindered amine-based thermal stabilizer; various types of UV absorbers such as a benzophenone-based UV absorber, a benzotriazole-based UV absorber, and a benzoate-based UV absorber; various types of antistatic agents such as a nonionic antistatic agent, a cationic antistatic agent, and an anionic antistatic agent; various types of dispersants such as a bisamide-based dispersant, a wax-based dispersant, and an organometallic salt-based dispersant; various types of chlorine scavengers such as a carboxylic acid alkaline earth metal salt-based chlorine scavenger; various types of lubricants such as an amide-based lubricant, a wax-based lubricant, an organometallic salt-based lubricant, and an ester-based lubricant; various types of decomposition agents such as an oxide-based decomposition agent and a hydrotalcite-based decomposition agent; various types of metal deactivators such as a hydrazine-based metal deactivator and an amine-based metal deactivator; various types of flame retardants such as a bromine-containing organic flame retardant, a phosphoric acid-based flame retardant, antimony trioxide, magnesium hydroxide, and red phosphorus; various types of inorganic fillers such as talc, mica, clay, calcium carbonate, aluminum hydroxide, magnesium hydroxide, barium sulfate, glass fiber, carbon fiber, silica, calcium silicate, potassium titanate, and wallastonite; organic fillers; organic pigments; inorganic pigments; inorganic antimicrobial agents; and organic antimicrobial agents.

From the viewpoint of enhancing the heat resistance of a foam body, the amount of propylene resin, which is component (B), combined in the thermoplastic elastomer composition is not less than 5 parts by weight, preferably not less than 10 parts by weight, more preferably not less than 20 parts by weight, and particularly preferably not less than 40 parts by weight, relative to 100 parts by weight of component (A). Furthermore, from the viewpoint of enhancing the flexibility of a foam body, it is not more than 150 parts by weight, preferably not more than 120 parts by weight, more preferably not more than 100 parts by weight, and particularly preferably not more than 80 parts by weight.

From the viewpoint of enhancing the molding processability and the flexibility of a foam body, the amount of mineral oil, which is component (C), combined in the thermoplastic elastomer composition relative to 100 parts by weight of component (A) is not less than 5 parts by weight, preferably not less than 30 parts by weight, and yet more preferably not less than 50 parts by weight. Furthermore, from the viewpoint of enhancing the bleed resistance and the heat resistance of a foam body, it is not more than 300 parts by weight, preferably not more than 250 parts by weight, and more preferably not more than 200 parts by weight.

The thermoplastic elastomer composition used in the present invention is obtained by melt-kneading using a known thermal kneader such as a mixing roll, a kneader, a Banbury mixer, or an extruder the hydrogenated product, which is component (A), the propylene resin, which is component (B), the mineral oil, which is component (C), and another component such as an additive combined as required.

With regard to the foaming agent used in foam injection molding, a known agent such as a chemical foaming agent or a physical foaming agent may be used. With regard to the chemical foaming agent or the physical foaming agent, two or more types thereof may be used in combination. Furthermore, a chemical foaming agent and a physical foaming agent may be used in combination.

Examples of the chemical foaming agent include an inorganic compound and an organic compound, and they may be used in a combination of two or more types. Examples of the inorganic compound include a hydrogen carbonate salt such as sodium hydrogen carbonate, and ammonium carbonate.

Furthermore, examples of the organic compound include a polycarboxylic acid, an azo compound, a sulfone hydrazide compound, a nitroso compound, p-toluenesulfonyl semicarbazide, and an isocyanate compound. Examples of the polycarboxylic acid include citric acid, oxalic acid, fumaric acid, and phthalic acid. Examples of the azo compound include azodicarbonamide (ADCA). Examples of the sulfone hydrazide compound include p-methylurethane benzenesulfonyl hydrazide, 2,4-toluenedisulfonyl hydrazide, and 4,4′-oxybisbenzenesulfonyl hydrazide. Examples of the nitroso compound include dinitrosopentamethylenetetramine (DPT).

Examples of the physical foaming agent include an inert gas and a volatile organic compound such as butane or pentane. As the physical foaming agent, an inert gas is preferable, and examples of the inert gas include carbon dioxide, nitrogen, argon, neon, and helium. Carbon dioxide and nitrogen are more preferable.

The amount of foaming agent used, relative to 100 parts by weight of the thermoplastic elastomer composition, is preferably 0.1 to 20 parts by weight, and more preferably 0.2 to 8 parts by weight. Furthermore, when a chemical foaming agent and a physical foaming agent are used in combination, the amount of chemical foaming agent used is preferably 0.05 to 5 parts by weight relative to 100 parts by weight of the thermoplastic elastomer composition.

With regard to the production process of the present invention, a thermoplastic elastomer composition and a foaming agent are injected by an injection molding machine into a cavity of a mold for injection molding and held for not less than 4 sec after injection is completed, and a wall face of the cavity is then moved to a predetermined position to thus enlarge the volume of the cavity, thereby molding a foam body.

As a method for supplying a chemical foaming agent to an injection molding machine, a method in which a chemical foaming agent that is melt-mixed with a thermoplastic elastomer composition in advance is supplied to an injection molding machine may be employed, but a method in which master batch pellets containing a chemical foaming agent are blended with thermoplastic elastomer composition pellets, and blended pellets are supplied to an injection molding machine is normally used.

As a method for supplying a physical foaming agent to an injection molding machine, a method in which a physical foaming agent is injected into a molten thermoplastic elastomer composition within a nozzle or a cylinder of an injection molding machine can be cited. From the viewpoint of enhancing the uniformity of foamed cells, a method in which a physical foaming agent is injected into a molten thermoplastic elastomer composition within a cylinder is preferable.

As an injection method, there can be cited as examples a single screw injection method, a multiple screw injection method, a high pressure injection method, a low pressure injection method, and a method using a plunger, etc.

Before injecting the thermoplastic elastomer composition and the foaming agent into the cavity of the mold, the pressure within the cavity is normally set at atmospheric pressure or below. Setting the pressure within the cavity at atmospheric pressure or below enables the appearance of a foam body to be enhanced.

As a method for setting the pressure within the cavity at atmospheric pressure or below, a known method is employed, and examples thereof include (1) a method in which a mold that can be evacuated is used, and the interior of a cavity is evacuated in advance, and (2) a method in which a mold having a degassing mechanism is used, and the pressure generated when injecting molten thermoplastic elastomer composition and foaming agent into a cavity is released outside the cavity by the degassing mechanism to thus make the pressure of the cavity equal to atmospheric pressure.

The volume of thermoplastic elastomer composition and foaming agent injected into the cavity may be the same volume as the cavity volume or may be smaller than it. Furthermore, when the volume is smaller, the cavity volume may be decreased immediately after injection so that the volume of thermoplastic elastomer composition and foaming agent becomes the same as the volume of the cavity. It is preferable that the volume of thermoplastic elastomer composition and foaming agent injected is the same as the cavity volume.

The temperature when injecting (molding temperature) is preferably 180° C. to 250° C. The injection time is preferably within 10 sec. Furthermore, the mold temperature is preferably 5° C. to 80° C.

In the present invention, after injection of the thermoplastic elastomer composition and the foaming agent into the cavity is completed, it is held for not less than 4 sec, and the cavity wall face is moved to a predetermined position to thus enlarge the cavity volume. The time after completion of injection until starting enlarging the cavity volume by moving the cavity wall face (delay time) is preferably not less than 5 sec from the viewpoint of enhancing the fineness and uniformity of foamed cells. Furthermore, the delay time is preferably not more than 30 sec from the viewpoint of enhancing the fineness and uniformity of foamed cells.

As a method for moving a mold cavity wall face to thus enlarge the cavity volume, a known method is used, and examples thereof include, for example, a method in which a core portion of a mold is moved back (the so-called core back) to thus enlarge the entire cavity, and a method in which a slide core is used to thus enlarge part of and/or the whole cavity.

The rate of enlargement of cavity volume when enlarging the cavity volume is preferably not less than 700%/sec, and more preferably not less than 2,000%/sec. Furthermore, the rate of enlargement of cavity volume is preferably not more than 25,000%/sec in terms of machine performance. The rate of enlargement of cavity volume is defined on the basis of the cavity volume after charging is completed being 100%, and when charging is carried out by decreasing the cavity volume immediately after injection, the cavity volume after decreasing is 100%.

After the cavity wall face is moved to a predetermined position, the thermoplastic elastomer composition within the cavity is cooled sufficiently. After cooling, a foam body is taken out from the mold.

The production process of the present invention may be carried out in combination with a molding method such as gas-assist molding, melt core molding, insert molding, core back molding, or two-color molding.

A skin material may be bonded to a foam body. Examples of the skin material include woven cloth; non-woven cloth; knitted cloth; film or sheet formed from thermoplastic resin or thermoplastic elastomer; polyurethane sheet; rubber sheet; polyurethane foam; ethylene vinyl acetate copolymer foam; polypropylene foam; and polyethylene foam.

A foam molding obtained by the process for producing a thermoplastic elastomer composition foam body of the present invention and a foam molding obtained using the thermoplastic elastomer composition for foam injection molding of the present invention have excellent fineness of foamed cells and excellent uniformity of foamed cells. Because of this, a foam body has an excellent feel of softness, and is excellent in terms of light weight, rigidity, and impact resistance.

A foam molding obtained by the process for producing a thermoplastic elastomer composition foam body of the present invention and a foam molding obtained using the thermoplastic elastomer composition for foam injection molding of the present invention are suitably used in automobile interior materials, consumer electronic products, furniture, etc.

In accordance with the present invention, there can be provided a process for producing by foam injection molding an aromatic vinyl compound-based thermoplastic elastomer composition foam body having foamed cells with excellent fineness and excellent uniformity.

Furthermore, in accordance with the present invention, there can be provided an aromatic vinyl compound-based thermoplastic elastomer composition for foam injection molding that gives a foam body having foamed cells with excellent fineness and excellent uniformity by foam injection molding, a foam body formed by foam injection molding of the thermoplastic elastomer composition, and a process for producing a foam body by foam injection molding the thermoplastic elastomer composition.

### EXAMPLES

The present invention is explained in more detail below by reference to Examples and Comparative Examples.

### [I] Methods for Measuring Physical Properties

### (1) Weight-Average Molecular Weight

Measured using a gel permeation chromatographic (GPC) method under conditions 1) to 8) below.

1) Device: Waters 150C, manufactured by Nihon Waters K.K.
2) Separation column: TSK gel GMH6-HT, manufactured by Tosoh Corporation
3) Measurement temperature: 140° C.
4) Carrier: ortho-dichlorobenzene
5) Flow rate: 1.0 mL/min
6) Amount injected: 500 μL
7) Detector: differential refractometer
8) Molecular weight reference material: standard polystyrene

### (2) Melt Flow Rate (MFR)

Measured in accordance with JIS K7210 with a load of 21.18 N at a temperature of 230° C.

### (3) Melt Tension

Tension was measured using a melt tension tester (Model MT-501D3, barrel diameter 9.55 mm) manufactured by Toyo Seiki Co., Ltd. when winding up by extruding 5 g of a sample in a molten state from an orifice having a diameter of 2 mm and a length of 8 mm under conditions of a temperature of 190° C. and a piston descent speed of 5.7 mm/minute, and winding up the extruded sample with a roller at a windup rate of 15.7 m/minute.

### (4) Fineness and Uniformity of Foamed Cells

A foam body was sectioned, and the section was examined using a microscope (DG-3 digital field microscope, manufactured by Scalar Corporation), and the fineness and uniformity of foamed cells were evaluated as follows.

### Fineness of Foamed Cells

Good: number-average diameter of cells was not more than 500 μm.
Poor: number-average diameter of cells was greater than 500 μm.

### Uniformity of Foamed Cells

Good: size and shape of cells were uniform.
Fair: no open cells were observed, but size and shape of cells were nonuniform.
Poor: open cells were observed, and size and shape of cells were nonuniform.

### (5) Oil Resistance

A sample (thermoplastic elastomer composition) was preheated for 5 minutes at a temperature of 230° C., and pressed for 5 minutes to obtain a molten sample. The molten sample was cooled to 30° C. under pressure for 5 minutes, and compression molded to obtain a compression sheet with a thickness of 1 mm. A hollow cylinder was set on the compression sheet. The hollow cylinder was made of fluoride resin (trade name: Teflon), and had an inner diameter of 38 mm, an outer diameter of 42 mm, and a height of 15 mm. Into the circular cylinder 1.5 g of liquid paraffin was poured. A 500 g weight was set on the circular end of the hollow cylinder to apply the constant load to the compression sheet. The constant load was applied to the compression sheet for 24 hours at a temperature of 80° C. The compression sheet was cooled to room temperature (25° C.), and then evaluated as follows.

Good: no swell were observed
Poor: swell was observed

### [II] Starting Materials

### (1) Hydrogenated Product of Styrene-Conjugated Diene-Styrene Block Copolymer

A-1: hydrogenated product of styrene-butadiene-styrene block copolymer (weight-average molecular weight 320,000, styrene content 33% by weight, degree of hydrogenation 100%)
A-2: hydrogenated product of styrene-isoprene-styrene block copolymer (weight-average molecular weight 129,000, styrene content 13% by weight, degree of hydrogenation 100%)
A-3: hydrogenated product of styrene-isoprene-styrene block copolymer (weight-average molecular weight 126,000, styrene content 18% by weight, degree of hydrogenation 99%)
A-4: hydrogenated product of styrene-butadiene-styrene block copolymer (weight-average molecular weight 101,000, styrene content 30% by weight, degree of hydrogenation 99%)

### (2) Propylene Resin

B-1: NOBLEN HR100EG (trade name) manufactured by Sumitomo Chemical Co., Ltd. (MFR=19 g/10 minutes, melt tension=0.33 cN)

### (3) Mineral Oil

C-1: Diana Process Oil PW-100 (trade name) manufactured by Idemitsu Kosan Co., Ltd. (pour point=−15° C.)

### Example 1

### Preparation of Thermoplastic Elastomer Composition

100 parts by weight of the hydrogenated product of a styrene-conjugated diene-styrene block copolymer A-1, 70 parts by weight, relative to 100 parts of A-1, of the propylene resin B-1, 180 parts by weight, relative to 100 parts of A-1, of the mineral oil C-1 and, relative to 100 parts by weight of the total of A-1, B-1, and C-1, 0.05 parts by weight of erucamide (NEUTRON S (trade name) manufactured by Nippon Fine Chemical), 0.05 parts by weight of calcium stearate, and 0.15 parts by weight of antioxidant (IRGANOX 1010 (trade name) manufactured by Ciba Specialty Chemicals: 0.1 parts by weight, Ultranox 626 (trade name) manufactured by GE Specialty Chemicals: 0.05 parts by weight) were melt-kneaded in a Banbury mixer and then molded into pellets, thus giving thermoplastic elastomer composition pellets.

### (Production of Injection-Foamed Molding)

Foam injection molding was carried out using an ES2550/400HL-MuCell manufactured by ENGEL as an injection molding machine (mold clamp force 400 t) with a mold having a box shape with molding dimensions of 290 mm×370 mm, height 45 mm, thickness 1.5 mm (gate structure: valve gate, molding central portion). 100 parts by weight of the thermoplastic elastomer composition pellets combined with 1 part by weight of an organic acid salt-based foaming agent master batch (MB3083 (trade name) manufactured by Sankyo Kasei Co., Ltd.) as a chemical foaming agent was supplied to the injection molding machine and melted within a cylinder of the injection molding machine, and carbon dioxide was pressurized to 6 MPa and supplied into the cylinder (amount of carbon dioxide injected relative to 100 parts by weight of pellet molten resin of the thermoplastic elastomer composition: 0.6 parts by weight). Subsequently, the thermoplastic elastomer composition and the foaming agent were injected at a molding temperature of 210° C. and a mold temperature of 20° C. for an injection time of 2.6 sec to thereby fully fill the cavity of the mold therewith, and they were held for 8 sec after filling (delay time 8 sec). Subsequently, a cavity wall face was moved back by 3 mm at a rate of enlargement of cavity volume of 7,000%/sec (the cavity volume when injection was completed being 100%) to thereby enlarge the volume of the cavity, thus carrying out foaming, and cooling and solidification were further carried out, thus giving a foam molding. The evaluation results are given in Table 1. The evaluation result of the compression sheet are given in Table 2.

### Example 2

The procedure of Example 1 was repeated except that 100 parts by weight of the hydrogenated product of a styrene-conjugated diene-styrene block copolymer A-2 was used instead of the hydrogenated product of a styrene-conjugated diene-styrene block copolymer A-1, the propylene resin B-1 was 56 parts by weight relative to 100 parts of A-2, and the mineral oil C-1 was 67 parts by weight relative to 100 parts of A-2. The evaluation results are given in Tables 1 and 2.

### Example 3

The procedure of Example 1 was repeated except that 100 parts by weight of the hydrogenated product of a styrene-conjugated diene-styrene block copolymer A-3 was used instead of the hydrogenated product of a styrene-conjugated diene-styrene block copolymer A-1, the propylene resin B-1 was 56 parts by weight relative to 100 parts of A-3, and the mineral oil C-1 was 67 parts by weight relative to 100 parts of A-3. The evaluation results are given in Tables 1 and 2.

### Example 4

The procedure of Example 1 was repeated except that 100 parts by weight of the hydrogenated product of a styrene-conjugated diene-styrene block copolymer A-4 was used instead of the hydrogenated product of a styrene-conjugated diene-styrene block copolymer A-1, the propylene resin B-1 was 50 parts by weight relative to 100 parts of A-4, and the mineral oil C-1 was 100 parts by weight relative to 100 parts of A-4. The evaluation results are given in Tables 1 and 2.

### Comparative Example 1

The procedure of Example 1 was repeated except that the delay time was changed to 2 sec. The evaluation results are given in Table 3.

### Comparative Example 2

The procedure of Example 2 was repeated except that the delay time was changed to 2 sec. The evaluation results are given in Table 3.

### Comparative Example 3

The procedure of Example 3 was repeated except that the delay time was changed to 2 sec. The evaluation results are given in Table 3.

### Comparative Example 4

The procedure of Example 4 was repeated except that the delay time was changed to 2 sec. The evaluation results are given in Table 3.

### Comparative Example 5

The procedure of Example 1 was repeated except that the delay time was changed to 2 sec, and the rate of enlargement of cavity volume was changed to 70%/sec. The evaluation results are given in Table 3.

TABLE 1

| | | Ex. 1 | Ex. 2 | Ex. 3 | Ex. 4 |
|---|---|---|---|---|---|
| Composition | | | | | |
| A-1 | Parts by | 100 | — | — | — |
| | weight | | | | |
| A-2 | Parts by | — | 100 | — | — |
| | weight | | | | |
| A-3 | Parts by | — | — | 100 | — |
| | weight | | | | |
| A-4 | Parts by | — | — | — | 100 |
| | weight | | | | |
| B-1 | Parts by | 70 | 56 | 56 | 50 |
| | weight | | | | |
| C-1 | Parts by | 180 | 67 | 67 | 100 |
| | weight | | | | |
| Molding conditions | | | | | |
| Delay time | Sec. | 8 | 8 | 8 | 8 |
| Rate of | %/sec. | 7,000 | 7,000 | 7,000 | 7,000 |
| enlargement of | | | | | |
| cavity volume | | | | | |

| | | | | |
|---|---|---|---|---|
| Evaluation results | | | | |
| Fineness | Good | Good | Good | Good |
| Uniformity | Good | Good | Good | Good |

TABLE 2

| Compression sheet | Ex. 1 | Ex. 2 | Ex. 3 | Ex. 4 |
|---|---|---|---|---|
| Oil resistance | Good | Poor | Poor | Poor |

TABLE 3

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Composition | | | | | | |
| A-1 | Parts by | 100 | — | — | — | 100 |
| | weight | | | | | |
| A-2 | Parts by | — | 100 | — | — | — |
| | weight | | | | | |
| A-3 | Parts by | — | — | 100 | — | — |
| | weight | | | | | |
| A-4 | Parts by | — | — | — | 100 | — |
| | weight | | | | | |
| B-1 | Parts by | 70 | 56 | 56 | 50 | 70 |
| | weight | | | | | |
| C-1 | Parts by | 180 | 67 | 67 | 100 | 180 |
| | weight | | | | | |
| Molding conditions | | | | | | |
| Delay time | Sec. | 2 | 2 | 2 | 2 | 2 |
| Rate of | %/sec. | 7,000 | 7,000 | 7,000 | 7,000 | 70 |
| enlargement of | | | | | | |
| cavity volume | | | | | | |

| | | | | | |
|---|---|---|---|---|---|
| Evaluation results | | | | | |
| Fineness | Poor | Poor | Poor | Poor | Poor |
| Uniformity | Poor | Poor | Poor | Poor | Poor |

1. A process for producing a thermoplastic elastomer composition foam body comprising the steps of (i), (ii) and (iii), in this order,
(i) injecting by an injection molding machine into a cavity of a mold for injection molding a foaming agent and a thermoplastic elastomer composition comprising
100 parts by weight of component (A),
5 to 150 parts by weight of component (B), and
5 to 300 parts by weight of component (C),
(ii) holding for not less than 4 seconds after completion of the injection, and
(iii) enlarging the volume of the cavity by moving a wall face of the cavity to a predetermined position, wherein
component (A) is a hydrogenated product of a block copolymer comprising a block composed of an aromatic vinyl compound-based monomer unit and a block composed of a conjugated diene compound-based monomer unit,
component (B) is a propylene resin, and
component (C) is a mineral oil.

2. The process according to claim 1, wherein in the step (iii) a rate of enlargement of cavity volume is not less than 700%/sec.

3. The process according to claim 1, wherein component (A) has a content of the block composed of the aromatic vinyl compound-based monomer unit of not less than 5% by weight but not more than 50% by weight, relative to 100% by weight of the total content of the block composed of the aromatic vinyl compound-based monomer unit and the block composed of the conjugated diene compound-based monomer unit.

4. The process according to claim 1, wherein component (A) has a degree of hydrogenation of not less than 50%.

5. The process according to claim 1, wherein component (A) has a weight-average molecular weight of not less than 50,000 but not more than 500,000.

6. The process according to claim 1, wherein component (B) has a melt flow rate under a load of 21.18 N at temperature 230° C. of not less than 0.1 g/10 minutes but not more than 300 g/10 minutes.

7. The process according to claim 1, wherein component (C) has an average molecular weight of not less than 300 but not more than 1,500 and a pour point of not more than 0° C.

8. A thermoplastic elastomer composition for foam injection molding, comprising
100 parts by weight of component (A′),
5 to 150 parts by weight of component (B′), and
5 to 300 parts by weight of component (C), wherein
component (A′) is a hydrogenated product of a block copolymer comprising a block composed of an aromatic vinyl compound-based monomer unit and a block composed of a conjugated diene compound-based monomer unit, the hydrogenated product having a weight-average molecular weight of not less than 200,000,
component (B′) is a propylene resin having a melt flow rate of 2 to 300 g/10 minutes and a melt tension of not less than 3 cN, and
component (C) is a mineral oil.

9. The thermoplastic elastomer composition according to claim 8, further comprising component (B″), wherein the total content of component (B′) and component (B″) is 5 to 150 parts by weight relative to 100 parts by weight of component (A′), and
component (B″) is a propylene resin having a melt flow rate of less than 2 g/10 minutes or a melt tension of less than 3 cN.

10. A foam body formed by foam injection molding of the thermoplastic elastomer composition according to claim 8.

11. A process for producing a foam body, comprising the steps of
preparing the thermoplastic elastomer composition according to claim 8, and
foam injection molding the thermoplastic elastomer composition.

12. Use of the thermoplastic elastomer composition according to claim 8 as a composition for foam injection molding.
